(19) United States
(12) Patent Application Publication
(10) Pub. No.: US 2012/0295070 A1
(43) Pub. Date: Nov. 22, 2012

(54) SILAGE COVER

(75) Inventor: Holger Eggers, Fulda (DE)

(73) Assignee: RKW SE

(21) Appl. No.: 13/509,048

(22) PCT Filed: Nov. 9, 2010
(86) PCT No.: PCT/EP10/06799

§ 371 Date: Aug. 3, 2012

(30) Foreign Application Priority Data
Nov. 12, 2009 (DE) 10 2009 052 948.9

(51) Int. Cl. B32B 3/26; B32B 3/30; B32B 3/10

(52) U.S. Cl. 428/172; 428/319.9; 428/316.6; 442/1; 442/59; 442/290; 442/291; 442/287; 442/288; 442/398; 442/394; 442/395; 442/396; 428/195.1

(57) ABSTRACT

The present invention relates to silo covers comprising at least two layers, wherein an inner first layer facing the silo is a single- or multi-ply plastic film having oxygen permeability according to DIN 53380-3 at 23° C. and 50% relative humidity of no more than 500 cm³/(m² d bar) and a water vapor transmission rate according to ISO 15106-3 at 23 ° C. and 85% relative humidity of at least 5 g/(m² d), and in at least one ply in total contains at least 50% by weight of one or more materials from the group comprising polyamide, copolyamide, polyester, copolyester, polyethylene vinyl alcohol, polyvinyl alcohol and mixtures thereof, and at least one second layer, which is located on top of the inner layer and is separate from the inner layer, or easy to separate therefrom, or self-separating on the silo, composed of at least 70% by weight of materials from the group comprising polyethylene, polypropylene, copolymers of ethylene and other vinyl monomers, and copolymers made of propylene and other vinyl monomers.

The present invention relates to a silage cover.

The process of ensiling has been commonly employed for many years so as to preserve forage in the agricultural industry. To this end, cut and optionally shredded fodder, typically grass or corn, is first compressed and then covered with one or more films such that preservative acidification of the silage is obtained due to lactic acid fermentation resulting from the absence of oxygen.

Silage can be entirely enclosed by film in tubular or bale-shaped shapes. This requires special harvesting machines so as to generate these units. The most significant, in terms of quantity, and most cost-effective type of silo construction, however, includes piling green fodder on the ground in heaps and covering it with films. Here, a distinction is made between bunker silos, which are enclosed on the bottom and on the lateral sides by concrete walls, and open silo pits, which have no constructed laterally delimiting walls. In the two latter variants, which hereafter will be referred to as heap silos, the lateral walls and the surface are covered and sealed by using plastic film.

Plastic films, which are used according to the prior art for covering and sealing heap silos, typically are predominantly made of polyethylene (PE) and copolymers of ethylene and other monomers, such as propylene, butene, propene, hexen, octene, ethylene vinyl acetate and the like. Examples include linear low-density polyethylene (PE-LLD), low-density polyethylene (PE-LD), high-density polyethylene (PE-HD), ethylene vinyl acetate (EVA), and ethylene-propylene copolymers (E/P).

For optical and/or functional reasons, these silo films according to the prior art are frequently implemented in multiple plies. For example, two-color films or films containing more economical compositions in the central ply are employed. A multi-ply film shall be understood to mean hereinafter that the individual plies are directly joined to each other, notably without any interposed air layers. In the prior art, multi-ply films are frequently produced by way of co-extrusion.

However, mono-films are also used, which consist of only a single ply.

It is further customary to use not only one, but several layers of differing polyolefin mono- and/or multi-ply films so as to cover heap silos. Hereinafter, a layer shall be understood to mean a structure which can be separated from the remaining layers by being easily pulled off and which is typically applied in a separate operation.

According to more recent prior art, first a thin polyolefin film, which hereinafter in accordance with common German parlance is referred to as an underlay film, is used, which is covered in a second operation with a thicker polyolefin film, which hereinafter in accordance with common German parlance is referred to as a silo film.

The thickness of conventionally used underlay films is approximately 40 μm, while the thickness of typically used silo films ranges between 100 and 200 μm.

According to the present state of the art, these two films are produced and delivered separately from each other and placed, in a labor intensive manner, separately from each other on a silo in two steps. Underlay films and silo films have previously not been supplied together on one roll, because this was only possible to implement, amongst other things, with high added technical complexity and therefore higher costs due to re-rolling, and the film rolls at times reach a high inherent weight, thereby making the use or placement thereof more difficult.

In addition to the individual or several polyolefin mono- and/or multi-ply films, according to the prior art an outer cover is frequently selected above the film cover so as to mechanically protect the silo. This outer cover is typically implemented in the form of a silo protection mesh, which according to the prior art is made of a polyolefin, preferably a high-pressure polyethylene-(HDPE) or polypropylene (PP)-based, woven fabric. The main functions of the outer cover are those of mechanical protection and protection from the weather of the silo film located beneath. The cover can also be composed of previously used silo films or other similar elements.

It is sufficiently known that the oxygen permeability of polyolefin silo films is comparatively high given the covalent nature of polyolefin plastic materials. In the German-speaking territory, for example, the relevant DLG standard and the other literature consider the upper limit of oxygen permeability to be 250 ml/(m² d bar) according to DIN 53380-3 at 23° C. and 50% relative humidity and that of oxygen partial pressure to be 0.2 bar. Yet even with oxygen permeability in keeping with this standard, aerobic fermentation processes continue to occur in the silo, resulting in spoilage and loss of fodder.

In addition to polyolefin plastic films, multi-ply films using different polymers are therefore known for covering heap silos, so as to prevent the problem of high oxygen permeability of polyolefin films.

JP 2003276123 A discloses a three-ply film for bale ensilage of grass, wherein the outer plies are made of polyolefin plastic materials and the central ply is made of aliphatic polyamide.

DE 102004008085 A1 describes a method for producing animal feed from biomass, wherein packaging that is oxygen- and air-tight to as great an extent as possible is selected. Multi-ply composite films comprising a barrier ply, preferably ethylene vinyl alcohol (EVOH), are described, wherein the composition of the composite film preferably comprises outer plies made of polyolefin plastic materials, with a central ply made of EVOH.

WO 99/29154 discloses a silo cover made of a single- or multi-ply film containing at least one airtight ply, preferably made of polyamide (PA). Other plastic materials that can be employed include ethylene vinyl alcohol (EVOH), polyvinyl alcohol (PVOH), and mixtures thereof, or mixtures with other plastic materials. Customary forms of the films are sold as coextrudates with a PE/PA/PE composition by Bruno Rimini Ltd., GB, and in use are provided with an additional cover offering mechanical protection.

Single- or multi-ply, thermally insulating cover films for use in agriculture, which should comprise at least one layer made of polyamide, are known from WO 2009/060480.

During realization of ensilage the recurring problem of mold formation on the surface of the product being ensiled toward the film is encountered, because of moisture precipitates that are due to condensation on the film surface facing the silage, which cannot escape to the outside due to the high water vapor barrier action of polyolefin films.

In addition to the absence of oxygen, another essential requirement of silo films is sufficient mechanical durability. The operator or installer of a heap silo must be able in particular to step onto the silo film or the outermost cover of the silo for inspection purposes. In addition, the cover must offer protection from damage by birds, hail and the like. An essential film property characterizing mechanical strength that has evolved over time is dart drop impact according to EN ISO 7765-1. In practice, a dart drop of at least 300 g has been found to be necessary, for premium silo covers it is at least 450 g.

Resource efficiency of silo films is increasingly gaining in importance. The essential factor here is, first of all, to lower material use. By nature, films having a low base weight exhibit considerable advantages. In addition, the recyclability of silo films is of high importance for resource efficiency. Only pure films, such as polyolefin films, can be recycled as material after use and cleaning. Composite films made of differing materials cannot be recycled in a value-conserving manner and instead must be returned to lesser-value uses after regeneration, which is also referred to as downcycling.

All films known according to the prior art for ensilage which have an improved oxygen barrier have the drawback that moisture pockets form beneath the film due to condensation and the barrier action of the film. Contrary to pure polyolefin films, they are additionally not suitable for value-preserving recycling and pose a disposal problem for the user after use.

The problem at hand is therefore that of providing a recyclable silo cover which uses little material and lowers the loss of feed unavoidable when using silo films according to the prior art due to high oxygen permeability and/or superficial moisture pockets, yet also offers high mechanical strength and protection of the silo content from drying out. The entire cover should also be able to be applied on the silo in a single operation and be easier to handle as a result of a material reduction that is possible as compared to covers according to the prior art, based on the improved material properties.

The stated problem is solved according to the invention by an at least double-layer silo cover, which comprises an inner, first layer which faces the silo and is composed of an airtight and water vapor-permeable single- or multi-ply plastic film, and at least one further second layer, which is located thereon and separate from the inner layer, or easy to separate therefrom, or self-separating on the silo, and which contains at least 70% by weight of materials from the group consisting of polyethylene, polypropylene, copolymers of ethylene and other vinyl monomers, and copolymers of propylene and other vinyl monomers, wherein the oxygen permeability of the first layer is no more than 500 cm³/(m² d bar) and the water vapor transmission rate thereof is at least 5 g/(m² d), and in at least one layer contains a total of at least 50% by weight of one or more materials from the group consisting of polyamide, copolyamide, polyester, copolyester, polyethylene vinyl alcohol, polyvinyl alcohol and mixtures thereof.

Oxygen permeability is determined within the scope of the present invention according to DIN 53380-3 at 23° C. and 50% relative humidity, and the water vapor transmission rate is determined according to ISO 15106-3 at 23° C. and 85% relative humidity. The oxygen permeability of the first layer is preferably no more than 100 cm³/(m² d bar) and the water vapor transmission rate thereof is at least 25 g/(m² d).

The first layer preferably is a single- or multi-ply film, which in each ply contains, in total, at least 30%, preferably at least 50%, and more preferably at least 70% of one or more materials from the group comprising polyamide, copolyamide, polyester, copolyester, EVOH and PVOH. A first layer which, in every ply, contains no more than 20% additional polymeric components, and more preferably none at all, aside from materials from the group comprising polyamide, copolyamide, polyester, copolyester, EVO and PVOH, is particularly preferred.

Still more particularly preferred are mixtures of polyamides and copolyamides, preferably mixtures of PA6, PA6/66, PA66, PA 6I6T and/or other aliphatic, aromatic or partially aromatic polyamides or copolyamides. The first layer therefore, preferably contains, in every ply, in total, at least 50%, particularly preferred at least 70%, and still more preferred at least 90% of one or more materials from the group comprising polyamide and copolyamide, preferably PA6, PA66, PA6/66, PA 6I6T and/or other aliphatic, aromatic or partially aromatic polyamides or copolyamides. Especially preferred is a first layer in the form of a single- or multi-ply film, which in each ply contains mixtures of PA6 and other polyamides and/or copolyamides, still more preferred contains mixtures of PA6 and PA6/66. It is further preferred if no additional polymer materials aside from polyamide and copolyamide are present.

In one, more or all plies, the first layer can contain additives such as those used to increase UV radiation stability and/or lubricants and/or mineral anti-block additives to lower the coefficient of friction of the film surface and/or additives for coloring.

It has proven advantageous to place the silo cover according to the invention with a higher water content in the first layer than that which is present after extrusion of the film. A moisture content of 2% by weight or more, relative to the materials from the group consisting of polyamide, copolyamide, polyester, copolyester, EVOH and PVOH present in the first layer, is preferred. The water content can be introduced, for example, by spray nozzles or a water bath during production.

The thickness of the first layer is advantageously at least 10 μm and no more than 200 μm, and preferably at least 15 μm and no more than 50 μm. The width typically ranges from 6 m to 22 m, and preferably from approximately 8 m to 16 m.

From a manufacturing point of view, a version of the silo cover according to the invention which comprises a first layer in the form of a single-ply plastic film has been found to be advantageous.

The second layer preferably contains low-density polyethylene (LDPE), medium-density polyethylene (MDPE), high-density polyethylene (HDPE), copolymers of ethylene and α-olefins (LLDPE), copolymers of ethylene and vinyl acetate (EVA), copolymers of ethylene and ethylenically unsaturated acids or esters, in particular acrylic acid, methacrylic acid and the esters thereof (ethylene methylacrylate (EMA), ethylene ethylacrylate (EEA), ethylene butylacrylate (EBA)), polypropylene (PP), heterophasic (block co-PP) or homogeneous (random co-PP) copolymers of propylene and ethylene. Advantageously no other polymeric materials are contained, aside from materials from the group consisting of polyethylene, polypropylene, copolymers of ethylene and other vinyl monomers, and copolymers of propylene and other vinyl monomers. Vinyl monomers shall be understood to mean those which contain an ethylene group and can be copolymerized with ethylene. These include primarily, but not exclusively, α-olefins having 2 to 12 carbon atoms—for example ethylene, propylene, butene, pentene, hexene, octane-; acrylic acid and the esters thereof; methacrylic acid and the esters thereof; styrene; dienes—for example butadiene, isoprene-; vinyl acetate; cycloolefins—for example norbornene, cyclopentadiene-; and carbon monoxide.

The second layer can contain mineral fillers, including, for example, but not exclusively, calcium carbonate or French chalk, so as to increase stiffness. The second layer can contain additives in the usual quantities, for example UV stabilizers and/or lubricants and/or mineral anti-block additives, so as to lower the coefficient of friction of the film surface and/or additives for coloring the film.

In a preferred embodiment, the second layer is a, preferably extruded, single- or multi-ply plastic film having a lower water vapor transmission rate than the first layer. A water vapor transmission rate of no more than 2.5 g/(m² d) is particularly preferred. This protects the product being ensiled from direct contact with water by condensation on the one hand and also prevents excessive drying out of the silo on the other. A thickness between 50 μm and 200 μm, particularly preferred between 50 and 150 μm, and still more preferably between 60 and 120 μm, is preferred.

In an alternative embodiment, the second layer is a coated or uncoated woven fabric, or a coated or uncoated net, or a coated or uncoated non-woven fabric, or a coated or uncoated mesh. For this purpose, advantageously commercially available, reusable silo protection mesh made of HDPE or PP may be used. Typical basis weights range from 100 g/m² to 400 g/m², and more preferably from 200 g/m² to 350 g/m². In addition, commercially available reusable woven fabric made of filets of PP or HDPE may be used. These typically have basis weights in the range of from 100 g/m² to 600 g/m², and more preferably from 200 g/m² to 400 g/m².

In a third embodiment, a second layer in the form of a single- or multi-ply film, as described above, is combined with a third layer, which is a coated or uncoated woven fabric, or a coated or uncoated net, or a coated or uncoated non-woven fabric, or a coated or uncoated mesh, as described above.

Moreover, it is possible to provide additional layers beneath the first layer and/or between the first and second layers and/or above the second or third layer. However, with respect to cost and complexity, silo covers are preferred in which the first layer rests directly on the product being ensiled and either a second layer, in form of a plastic film, rests on the first layer, covered or not covered by a mesh, woven fabric, net or non-woven fabric, or a second layer, in form of a mesh, woven fabric, net or non-woven fabric, rests directly on the first layer, without further layers being provided.

It is preferred for the first layer and second layer, and optionally further layers, to be provided as separate layers, yet in a ready-made unit, wherein all such ready-made layers are rolled and/or folded together such that they can be unrolled and/or unfolded and placed onto the heap silo in a single operation.

If the second layer is a single- or multi-ply plastic film, it is particularly advantageous for the first layer and the second layer to be produced by way of co-extrusion with low adhesive bonding between the layers as a separable and/or self-separating variant. This is sufficiently known in the expert community because, for example with barrier films for packaging, the plies are firmly bonded using adhesion promoters so as to suppress the effect of separability or self-separation. In the absence of adhesion promoter, the first layer will separate from the second layer prior to being applied, during application, and optionally by active separation of the layers using mechanical aids in the production or finishing phase, or by the person applying them, or after lying on the heap silo for several days, favored by different physical-chemical effects (evaporation, diffusion and condensation processes, which exist due to the different molecular structures of the materials used). This mode of production is particularly suited for a silo cover according to the invention, in which the first layer is composed of one or more plies, containing in each ply mixtures of PA6 and other polyamides and/or copolyamides, still more preferably mixtures of PA6 and PA6/66, and in which at least 70% of the second layer is composed of materials comprising low-density polyethylene (LDPE), medium-density polyethylene (MDPE), high-density polyethylene (HDPE), copolymers of ethylene and α-olefins (LLDPE), copolymers of ethylene and vinyl acetate (EVA), copolymers of ethylene and acids or acrylates (EMA, EEA, EBA), polypropylene (PP), heterophasic (block co-PP) or homogeneous (random co-PP) copolymers of propylene and ethylene.

In a preferred embodiment, at least one layer is composed of an extruded single- or multi-ply plastic film comprising at least one ply that contains a foam structure. This is particularly advantageous for separating the first and second layers in silo covers produced by way of co-extrusion with low adhesive bonding.

It is possible to dye one or more layers of the silo cover according to the invention and/or to imprint it and/or provide it with stripe-shaped markings.

The invention will be described based on the following examples, without being limited to the embodiments that are described in detail. Unless stated otherwise or unless the context requires otherwise, the percentage information relates to the weight, in case of doubt to the total weight of the mixture.

The invention also relates to all possible combinations of advantageous and preferred embodiments, provided they do not mutually exclude each other. The expressions “approximately” or “about” in conjunction with numerical data shall mean that at least values that are higher or lower by 10%, or values that are higher or lower by 5%, and in any case values that are higher or lower by 1%, shall be included.

### EXAMPLE 1

Separate unit: An underlay film made of 80% PA6/66 (Ultramid® C33 L 01, BASF SE) and 20% PA6 (Ultramid B40, BASF SE) was extruded in a thickness of 18 μm and a width of 8 m on a customary equipment for producing blown films as a mono-film. This first layer was combined with a commercially available polyolefin silo film from RKW SE, distributed under the trade name of wepelen® Siloplus, having a thickness of 80 μm and a width of 8 m, as the second layer.

### EXAMPLE 2

Separable and/or separating unit: A film as in Example 1 was produced by way of co-extrusion, wherein the first ply having a thickness of approximately 18 μm as the first layer, or inner layer facing the silo, was made of PA as in Example 1, and the second and third plies as the second layer, facing away from the silo, had a thickness of 80 μm similarly to a commercially available polyolefin silo film and were made of polyethylene. In this way, a 3-ply co-extruded film having a width of 8 m was produced, in which it was possible to pull the first layer (inside layer) off the second layer (central and outer layers), or the two layers detach from each other over time due to corresponding physical-chemical processes on the silo.

### EXAMPLE 3 (COMPARISON)

For comparison, solely the underlay film from Example 1 was used.

### EXAMPLE 4 (COMPARISON)

A film such as the underlay film in Example 1 was blow-extruded in a thickness of 35 μm and used as in Example 3 as the sole silo cover.

### EXAMPLE 5 (COMPARISON)

A commercially available polyolefin underlay film from RKW SE, distributed under the trade name of wepelen® Silo 40, and having a thickness of 40 μm and a width of 8 m, was used as another comparison film.

### EXAMPLE 6 (COMPARISON)

Another comparison film used was the commercially available polyolefin silo film which forms the second layer in Example 1, however in a thickness of 150 μm.

### EXAMPLE 7 (COMPARISON)

A combination of an underlay film according to Example 5 and a silo film according to Example 6 was used as another comparison film.

### EXAMPLE 8 (COMPARISON)

A combination of an underlay film according to Example 5 and a silo film according to Example 6 was used as further comparison film, the silo film however having a thickness of 60 μm.

### EXAMPLE 9 (COMPARISON)

A commercially available film of the type “Silostop®” having a PE/PA/PE composition and a thickness of 45 μm was used as another comparison film.

For all films or film combinations, the following parameters were determined: thickness according to DIN 53370, basis weight according to EN ISO 2286-2, water vapor transmission rate according to ISO 15106-3 at 23° C. and 85% relative humidity, oxygen permeability according to DIN 53380-3 at 23° C. and 50% relative humidity, and dart drop impact according to ISO 7765 -1 method A, for film combinations determined by adding the individual values.

The silo covers were applied to a heap silo containing corn silage. In addition to the physical properties measured in the laboratory, it was observed to what extent the surface of the silage is free from moisture pockets due to condensation on the inside of the silo cover. All results are summarized in Table 1.

TABLE 1

| | Example | | | | | | | | |
|---|---|---|---|---|---|---|---|---|---|
| | 1 | 2 | 3 | 4 | 5 | 6 | 7 | 8 | 9 |
| Thickness [μm] | 100 | 100 | 18 | 35 | 40 | 150 | 190 | 100 | 45 |
| Basis weight g/m² | 94 | 94 | 21 | 41 | 37 | 138 | 175 | 94 | 42 |
| Water vapor transmission | 1.0 | 1.0 | 70 | 35 | 1.5 | 0.5 | 0.4 | 1.0 | 1.6 |
| rate [g/(m² d)] | | | | | | | | | |
| Oxygen permeability | 30 | 30 | 30 | 15 | 4710 | 1195 | 910 | 2450 | 65 |
| [N cm³/(m² d bar)] | | | | | | | | | |
| Dart Drop [g] | 850 | 850 | 603 | 690 | 131 | 304 | 435 | 280 | 760 |
| Recyclability as material | Yes | Yes | Yes | Yes | Yes | Yes | Yes | Yes | No |
| Moisture pockets | No | No | No | No | No | Yes | Yes | Yes | Yes |
| Drying-out and loss of | No | No | Yes | Yes | No | No | No | No | No |
| quality of the top layer in | | | | | | | | | |
| the silo | | | | | | | | | |

Surprisingly it was found that the compaction of the topmost layer in the silo considerably decreased over time when covered according to comparative example 4. This resulted in deviating coloring of the topmost layer. This phenomenon can be explained by the superficial drying out of the silo, whereby cohesion within the topmost silage ply decreased and the same consequently expanded. The locally reduced compaction directly resulted in worse silage quality of the topmost ply.

Compared to commercially available pure polyolefin silo covers according to comparative examples 6 and 7, the silo cover according to the invention according to example 1 or 2 has the significant advantage of lower oxygen permeability and higher mechanical strength. Thus, with improved conditions for a good silage result, a surprisingly significant reduction in the film thickness, and hence in the use of resources, is achieved.

Compared to a composite film made of polyethylene and polyamide according to comparative example 9, the silo cover according to the invention according to example 1 or 2 has the advantage of being recyclable as material, and consequently likewise a lower use of resources. Moreover, during the use in the silo it is surprising that the formation of condensate beneath the silo cover is effectively prevented, so that the formation of mold is lastingly avoided.

Compared to a pure PA mono-film according to comparative example 4, the silage does not dry out when using the cover according to the invention, so that the quality of the silage is likewise improved.

The silo cover according to the invention exhibits the required properties. All layers of the cover can be produced separately, separably or so as to self-separate. The silo cover is easy to recycle, as the different polymers are present in separate layers that are not permanently bonded to each other. It is not oxygen-permeable, which is indispensible for the production of high-quality silage. It prevents mold caused by moisture pockets because the water vapor barrier layer only rests on top, while also preventing the product being ensiled from drying out. It contains only approximately 30-70% of the mass of a comparable standard cover and is therefore considerably easier to handle. Because the films can be placed down in one operation, and the cover has a considerably lower mass due to the material reduction (Compare example 1 or 2 to example 7), it is considerably easier for the user to apply. At a dart drop impact of at least 300 g, and typically at least 450 g and higher, it satisfies the mechanical requirements of a silo cover encountered in practice.

1. A silo cover, comprising at least two layers, having an inner first layer facing the silo and at least one further second layer, which is located thereon and is separate from the inner layer, or easy to separate therefrom, or self-separating on the silo, and which contains at least 70% by weight of materials from the group comprising polyethylene, polypropylene, copolymers of ethylene and other vinyl monomers, and copolymers made of propylene and other vinyl monomers, wherein the first layer is a single- or multi-ply plastic film having oxygen permeability according to DIN 53380-3 at 23° C. and 50% relative humidity of no more than 500 cm³/(m² d bar) and a water vapor transmission rate according to ISO 15106-3 at 23° C. and 85% relative humidity of at least 5 g/(m² d), and in at least one ply in total contains at least 50% by weight of one or more materials from the group comprising polyamide, copolyamide, polyester, copolyester, polyethylene vinyl alcohol, polyvinyl alcohol and mixtures thereof.

2. The silo cover according to claim 1, wherein the oxygen permeability of the first layer according to DIN 53380-3 at 23° C. and 50% relative humidity is no more than 100 cm³/(m² d bar) and the water vapor transmission rate thereof according to ISO 15106-3 at 23° C. and 85% relative humidity is at least 25 g/(m² d).

3. The silo cover according to claim 1, wherein the first layer, in at least one ply, contains no more than 20% additional polymeric components, aside from materials from the group comprising polyamide, copolyamide, polyester, copolyester, polyethylene vinyl alcohol, polyvinyl alcohol and mixtures thereof.

4. The silo cover according to claim 1, wherein the first layer, in at least one ply, contains mixtures of polyamides and/or copolyamides, and optionally additives to increase UV radiation stability and/or lubricants and/or mineral anti-block additives to lower the coefficient of friction of the film surface and/or additives for coloring the film.

5. The silo cover according to claim 1, wherein the first layer, in each ply, contains mixtures of polyamides and/or copolyamides, and optionally additives to increase UV radiation stability and/or lubricants and/or mineral anti-block additives to lower the coefficient of friction of the film surface and/or additives for coloring the film.

6. The silo cover according to claim 1, wherein the first layer is composed of a single-ply plastic film.

7. The silo cover according to claim 1, wherein the first layer has a thickness of at least 15 μm and no more than 50 μm.

8. The silo cover according to claim 1, wherein the second layer consists of an extruded single- or multi-ply plastic film.

9. The silo cover according to claim 1, wherein the water vapor transmission rate of the second layer is lower than that of the first layer.

10. The silo cover according to claim 9, wherein the water vapor transmission rate of the second layer according to ISO 15106-3 at 23° C. and 85% relative humidity is no more than 2.5 g/(m² d).

11. The silo cover according to claim 1, wherein the second layer contains at least 70% by weight of low-density polyethylene (LDPE), medium-density polyethylene (MDPE), high-density polyethylene (HDPE), copolymers of ethylene and α-olefins (LLDPE), copolymers of ethylene and vinyl acetate (EVA), copolymers of ethylene and acrylic acid, methacrylic acid or the esters thereof, polypropylene (PP), heterophasic (block co-PP) or homogeneous (random co-PP) copolymers of propylene and ethylene.

12. The silo cover according to claim 1, wherein the first layer consists of polyamides, copolyamides and optionally additives, and the second layer consists of at least 70% by weight of low-density polyethylene (LDPE), medium-density polyethylene (MDPE), high-density polyethylene (HDPE), copolymers of ethylene and α-olefins (LLDPE), copolymers of ethylene and vinyl acetate (EVA), copolymers of ethylene and acids or acrylates, polypropylene (PP), heterophasic (block co-PP) or homogeneous (random co-PP) copolymers of propylene and ethylene, and optionally additives.

13. The silo cover according to claim 8, wherein the first layer and the second layer are produced by way of co-extrusion with low adhesive bonding between the first layer and the second layer, whereby the first layer separates from the second layer prior to being applied, during application, or by active separation of the layers during application, or after lying on the heap silo for a few days.

14. The silo cover according to claim 8, wherein at least one layer, preferably the second layer, consists of an extruded single- or multi-ply plastic film comprising at least one ply that contains a foam structure.

15. The silo cover according to claim 1, wherein the second layer has a thickness of between 50 μm and 150 μm.

16. The silo cover according to claim 1, wherein the second layer is composed of a coated or uncoated woven fabric, or a coated or uncoated net, or a coated or uncoated non-woven fabric, or a coated or uncoated mesh.

17. The silo cover according to claim 1, wherein at least the first layer and the second layer are rolled and/or folded together such that they can be spread in a single operation by unrolling and/or unfolding.

18. The silo cover according to claim 1, wherein one or more layers are dyed and/or imprinted and/or contain stripe-shaped markings.

19. The silo cover according to claim 1, wherein the second layer is a single- or multi-ply film, and another layer made of a coated or uncoated woven fabric, or a coated or uncoated net, or a coated or uncoated non-woven fabric, or a coated or uncoated mesh, is arranged on top of the second layer.

20. Use of the silo cover according to claim 1 for covering heap silos such as bunker silos or open silo pits.
